(19) United States
(12) Patent Application Publication
(10) Pub. No.: US 2022/0189648 A1
(43) Pub. Date: Jun. 16, 2022

(54) NUCLEAR FUEL RODS AND RELATED METHODS

(71) Applicant: Battelle Energy Alliance, LLC, Idaho Falls, ID (US)

(72) Inventors: Isabella J. van Rooyen, Idaho Falls, ID (US); Youssef A. Ballout, Idaho Falls, ID (US)

(21) Appl. No.: 17/643,628

(22) Filed: Dec. 10, 2021

Related U.S. Application Data
(60) Provisional application No. 63/123,617, filed on Dec. 10, 2020.

(51) Int. Cl. G21C 3/06; G21C 3/04; G21C 3/18

(52) U.S. Cl. CPC G21C 3/06; G21C 3/18; G21C 3/047

(57) ABSTRACT

A nuclear fuel rod comprises a nuclear fuel material, a material surrounding the nuclear fuel material, and cladding surrounding the material, the material forming a fuel-cladding gap between the nuclear fuel material and the cladding. Related nuclear fuel rods and methods are also disclosed.

### CROSS-REFERENCE TO RELATED APPLICATION

This application claims the benefit under 35 U.S.C. §119(e) of U.S. Provisional Patent Application Ser. No. 63/123,617, filed Dec. 10, 2020, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### FIELD

Embodiments of the disclosure relate generally to nuclear fuel rods including a fuel-cladding gap, and to related methods of forming the nuclear fuel rods. More particularly, embodiments of the disclosure relate to nuclear fuel rods including a nuclear fuel material, cladding around the nuclear fuel material, and material in a gap between the nuclear fuel material and the cladding, and to methods of additively manufacturing the nuclear fuel rods.

### BACKGROUND

Nuclear reactors are used to generate power (e.g., electrical power) using nuclear fuel materials. Examples of nuclear reactors include pressurized water reactors (PWR), pressurized heavy water reactors (CANDU), gas-cooled reactors (GCR), boiling water reactors (BWR), supercritical water reactors (SCWR), liquid metal fast reactors (LMFR), advanced gas-cooled reactors (AGR), advanced nuclear reactors, modular reactors, and advanced small modular reactors (SMRs). Heat generated by nuclear reactions carried out within nuclear fuel materials of a nuclear reactor may be used to generate steam that is used to rotate a turbine. Rotation of the turbine is used to operate a generator for generating electrical power.

Nuclear reactors generally include a nuclear core, which is the portion of the nuclear reactor that includes the nuclear fuel material and generates heat from the nuclear reactions of the nuclear fuel material. The nuclear core may include a plurality of nuclear fuel rods, which include the nuclear fuel material. Fuel rods typically include the nuclear fuel material encased within a cladding material. The cladding material may be selected to be resistant to radiation damage (e.g., metal embrittlement caused by radiation exposure) and may be configured to withstand dimensional changes, such as those caused by thermal expansion of the nuclear fuel material and the cladding material.

In use and operation, nuclear fuel materials within the fuel rod may exhibit so-called swelling due to thermal expansion of the nuclear fuel material. During operation, the fuel rods are exposed to fission products (gases), which may lead to radiation-induced swelling of the nuclear fuel materials. The fission products may remain in spaces between the nuclear fuel material and the cladding material, also referred to as the fuel-cladding gap. The accumulation of fission gases (e.g., xenon, krypton, cesium, iodine) in the fuel-cladding gap may lower the thermal conductivity of the fuel rod by replacing high thermal conductivity gases (such as helium) with fission gases having a relatively lower thermal conductivity. Insufficient removal of heat from the fuel rod may lead to increased thermal expansion of the nuclear fuel material and greater deformation and corrosion of the cladding material. In addition, interaction of the fission products, the nuclear fuel material, and the cladding material may result in nucleation and propagation of cracks within the fuel rod and depressurization of the fuel rod.

In recent years, many new reactor designs have been proposed for nuclear reactors. However, the new reactor designs, such as small modular reactors and microreactors, utilize unique nuclear fuel materials, fuel rods, and cladding materials. Fabrication of such nuclear fuel materials and cladding materials may present difficulties, such as high development and testing costs, time of manufacture, and time of material and design qualification.

### BRIEF SUMMARY

In accordance with one embodiment described herein, a nuclear fuel rod comprises a nuclear fuel material, a material surrounding the nuclear fuel material and comprising a non-radioactive material, and cladding surrounding the material, the material defining a fuel-cladding gap between the nuclear fuel material and the cladding.

In other embodiments, a nuclear fuel rod comprises nuclear fuel pellets, cladding around the nuclear fuel pellets, and a gap-maintaining material between the nuclear fuel pellets and the cladding and comprising a different material composition than the nuclear fuel pellets and the cladding, the gap-maintaining material contacting the nuclear fuel pellets and the cladding.

In additional embodiments, a method of forming a structure comprises forming, by additive manufacturing, a first layer of a structure, the first layer comprising a first material, forming a second layer of the structure on the first layer, the second layer comprising a sacrificial material, forming a third layer of the structure on the second layer, the third layer comprising a second material having a different material composition than the first material, and selectively removing the sacrificial material with respect to the first material and the second material to form a structure comprising the first material spaced from the second material.

### BRIEF DESCRIPTION OF THE DRAWINGS

FIG. 1A is a simplified partial cross-sectional view of a fuel rod, in accordance with embodiments of the disclosure;

FIG. 1B is a simplified partial cross-sectional view of the fuel rod of FIG. 1A taken through section line B-B of FIG. 1A;

FIG. 1C is a simplified partial cross-sectional view of an auxetic structure, in accordance with embodiments of the disclosure;

FIG. 2A is a simplified partial cross-sectional view of a fuel rod, in accordance with embodiments of the disclosure;

FIG. 2B is a simplified partial cross-sectional view of the fuel rod of FIG. 2A taken through section line B-B of FIG. 2A;

FIG. 3A is a simplified partial cross-sectional view of a fuel rod, in accordance with embodiments of the disclosure;

FIG. 3B is a simplified partial cross-sectional view of the fuel rod of FIG. 3A taken through section line B-B of FIG. 3A;

FIG. 4A is a simplified partial cross-sectional view of a fuel rod, in accordance with embodiments of the disclosure;

FIG. 4B is a simplified partial cross-sectional view of the fuel rod of FIG. 4A taken through section line B-B of FIG. 4A;

FIG. 5 is a simplified schematic of a system for additively manufacturing one or more components of a structure;

FIG. 6 is a simplified schematic of a system for additively manufacturing one or more components of a structure, in accordance with embodiments of the disclosure; and

FIG. 7 is a simplified partial cross-sectional view of a fuel rod including a coating formed on the cladding, in accordance with embodiments of the disclosure.

### DETAILED DESCRIPTION

The following description provides specific details, such as material types, dimensions, and processing conditions in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional fabrication techniques employed in the industry. In addition, the description provided below does not form a complete process flow, apparatus, or system for forming a fuel rod including a fuel-cladding gap, a fuel rod including such a fuel-cladding gap, a system (e.g., an additive manufacturing system) for forming such a fuel rod, or a system (e.g., a nuclear reactor) including such a fuel rod. Only those process acts and structures necessary to understand the embodiments of the disclosure are described in detail below. Additional acts to form a final structure including the materials and methods described herein may be performed by conventional techniques. Also note, any drawings accompanying the present application are for illustrative purposes only, and are thus not drawn to scale. Additionally, elements common between figures may retain the same numerical designation.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

According to methods described herein, a structure including a first material, a second material, and a gap between the first material and the second material is formed by additive manufacturing. The gap may comprise a void (e.g., is filled with a gas) or may include one or more additional materials, such as, for example, a foam material, a thermal transfer structure, a porous material, a material configured to impart mechanical stability to the structure, an auxetic material, or a sacrificial material. In some embodiments, the structure comprises a fuel rod, wherein the first material comprises a nuclear fuel material, the second material comprises a cladding material, and the additional material comprises a material disposed in a fuel-cladding gap between the nuclear fuel material and the cladding material and having a different material composition than the nuclear fuel material and the cladding material. In some embodiments, the additional material comprises a non-radioactive material. The additional material may facilitate formation of the fuel rod while maintaining a separation (e.g., gap) between the nuclear fuel material and the cladding. The gap may function, during use and operation of the fuel rod, to reduce or prevent stress corrosion cracking of one or more components of the fuel rod, fuel-cladding interactions, and undesired contact between the nuclear fuel material and the cladding responsive to expansion of the nuclear fuel material. The additional material may facilitate improved properties of the fuel rod, such as one or more of improved thermal transfer away from the nuclear fuel material, improved mechanical stability (e.g., improved rigidity) of the fuel rod, improved flow of materials through the fuel-cladding gap, improved corrosion resistance of the fuel rod, and improved abrasion resistance of one or more components of the fuel rod.

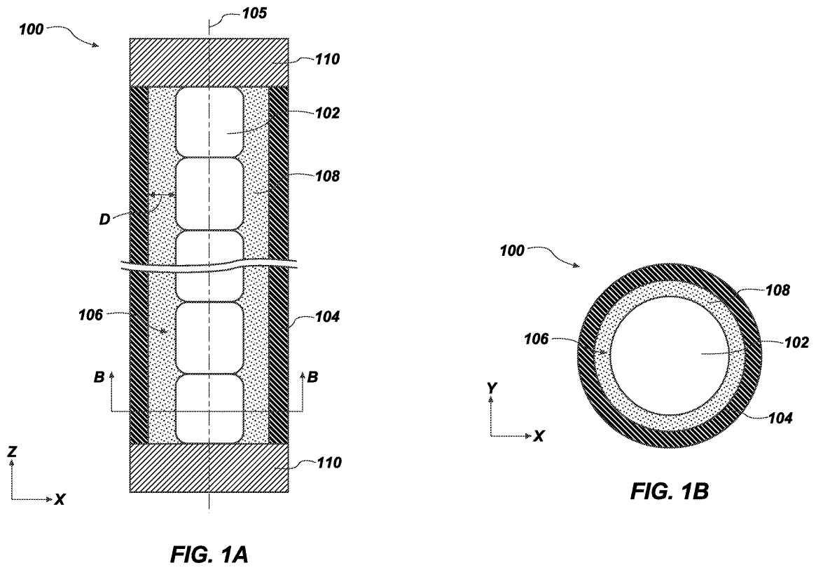

FIG. 1A is a simplified partial cross-sectional view of a fuel rod 100, in accordance with embodiments of the disclosure. FIG. 1B is a simplified partial cross-sectional view of the fuel rod 100 of FIG. 1A taken through section line B-B of FIG. 1A. With collective reference to FIG. 1A and FIG. 1B, the fuel rod 100 includes nuclear fuel pellets 102 (also referred to as “fuel pellets”) disposed longitudinally along a longitudinal axis 105 of the fuel rod 100. In some embodiments, the nuclear fuel pellets 102 are disposed substantially concentrically around the longitudinal axis 105.

The nuclear fuel pellets 102 may be enclosed by cladding 104 (also referred to as a “cladding tube” or a “cladding material”). The cladding 104 may be configured to contain the nuclear fuel pellets 102. A gap 106 between the nuclear fuel pellets 102 (e.g., the outer diameter of the nuclear fuel pellets 102) and the cladding 104 (e.g., the inner diameter of the cladding 104) may be referred to as a “fuel-cladding gap”. In some embodiments, an additional material 108 is disposed within the gap 106 and between the nuclear fuel pellets 102 and the cladding 104. In other embodiments, the gap 106 comprises one or more gases therein and is substantially free of a solid material or a liquid material.

Although FIG. 1A illustrates that the fuel rod 100 includes a plurality of nuclear fuel pellets 102, the disclosure is not so limited. In other embodiments, the fuel rod 100 includes a unitary nuclear fuel material.

The nuclear fuel pellets 102 may be formed of and include a nuclear fuel material. By way of non-limiting example, the nuclear fuel pellets 102 may be formed of and include one or more of uranium, uranium dioxide (UO₂), a uranium oxide (e.g., U₃O₈), uranium silicide (U₃Si₂), uranium carbide (UC), uranium-molybdenum fuels (e.g., U—Mo), uranium-beryllium (UBeₓ) and oxides thereof (e.g., BeO—UO₂), uranium dispersed in zirconium (e.g., U-10Zr (an alloy of uranium and about 10 weight percent zirconium)), tri-structural-isotropic (TRISO) fuel particles comprising uranium, carbon, and oxygen (e.g., a core containing one or more of UCO, UO₂, ThO₂, and a combination thereof, a transuranic carbide material, a buffer layer around the core, an inner carbon layer around the buffer layer, a ceramic layer around the inner carbon layer, and an outer carbon layer around the ceramic layer), uranium dispersed in a matrix material (e.g., uranium dispersed in a graphite matrix material), uranium nitride (UN), uranium sesquisilicide, uranium-plutonium-zirconium (U—Pt—Zr) alloys, uranium-zirconium-palladium-neodymium (U—Zr—Pd—Nd) alloys, uranium-zirconium-palladium-cerium (U—Zr—Pd—Ce) alloys, uranium-zirconium-palladium-praseodymium (U—Zr—Pd—Pr) alloys, uranium-zirconium-palladium-lanthanum (U—Zr—Pd—La) alloys, plutonium dioxide (PuO₂), and thorium silicide. In some embodiments, the nuclear fuel material comprises a ceramic material.

In some embodiments, the nuclear fuel material of the nuclear fuel pellets 102 includes one or more dopants, such as one or more of zirconium, titanium, vanadium, chromium, iron, cobalt, nickel, copper, zinc, palladium, silver, tin, hafnium, tantalum, tungsten, platinum, gold, lead, a metal oxide (e.g., aluminum oxide, zirconium oxide, etc.), nanotubes (e.g., single-walled carbon nanotubes, multi-walled carbon nanotubes, or a combination thereof), and carbon nanorods coated with a metal oxide (e.g., aluminum oxide, zirconium oxide). The dopant may be present within the nuclear fuel material at a concentration between about 1 part per billion (ppb) and about 1,000 ppb, such as between about 1 ppb and about 100 ppb, between about 100 ppb and about 500 ppb, or between about 500 ppb and about 1,000 ppb.

In some embodiments, the nuclear fuel pellets 102 include a burnable poison material, such as, for example, one or more of boron, gadolinium, gadolinium (III) oxide (Gd₂O₃), boron carbide (B₄C), and one or more neutron absorbers (e.g., one or more of krypton, molybdenum, neodymium, and hafnium).

The cladding 104 may comprise one or more of zirconium, iron, nickel, chromium, molybdenum, niobium, bismuth, stainless steel (e.g., austenitic 304 stainless steel, 316 stainless steel, HT-9 stainless steel (a ferritic steel comprising about 12.3 weight percent chromium, about 0.5 weight percent nickel, about 1.0 weight percent molybdenum, about 0.01 weight percent copper, about 0.3 weight percent vanadium, about 0.47 weight percent vanadium, the remainder comprising carbon, manganese, phosphorus), stainless steels including alloys of chromium and nickel), an oxide dispersion-strengthened alloy (ODS) including one or more nickel-based alloys, iron-based alloys, and aluminum-based alloys such as, for example, iron aluminide, iron chromium, iron-chromium-aluminum, nickel chromium, chromium-aluminum-silicon-nitride (CrAlSiN), and nickel aluminide, a nano-ferritic alloy (NFA), and a zirconium-based alloy. In some embodiments, the cladding 104 comprises a zirconium-based alloy, such as, for example, an alloy comprising zirconium and tin (e.g., zircaloy-2, zircaloy-4, Zirlo(™)).

A thickness of the cladding 104 (e.g., in the radial direction (e.g., the X-direction, the Y-direction) in the view of FIG. 1B) may be between about 0.5 μm and about 800 μm, such as between about 0.5 μm and 1.0 μm, between about 1.0 μm and about 5.0 μm, between about 5.0 μm and about 25 μm, between about 25 μm and about 50 μm, between about 50 μm and about 100 μm, between about 100 μm and about 250 μm, between about 250 μm and about 500 μm, or between about 500 μm and about 800 μm.

With reference to FIG. 1A, the fuel rod 100 comprises end caps 110 (also referred to as “end plugs”) at longitudinal ends of the fuel rod 100. The end caps 110 may be welded or otherwise secured to the longitudinal ends of the fuel rod 100. The end caps 110 may hermitically seal the fuel rod 100 and facilitate containment of the nuclear fuel pellets 102, the additional material 108, gases (e.g., helium) present within the gap 106, and any fission gases that may be generated during use and operation of the fuel rod 100.

The end caps 110 may be formed of and include a metal or metal alloy, such as one or more of the materials described above with reference to the cladding 104. In some embodiments, the end caps 110 comprise substantially the same material composition as the cladding 104. In other embodiments, the end caps 110 comprise a different material composition than the cladding 104. In some embodiments, the end caps 110 comprise a zirconium-based alloy, such as, for example, an alloy comprising zirconium and tin (e.g., zircaloy-2, zircaloy-4, Zirlo™).

A distance D between the nuclear fuel pellets 102 and the cladding 104 may be within a range of from about 10 μm to about 1,000 μm (about 1.0 mm), such as from about 10 μm to about 30 μm, from about 30 μm to about 50 μm, from about 50 μm to about 100 μm, from about 100 μm to about 250 μm, from about 250 μm to about 500 μm, or from about 500 μm to about 1,000 μm.

The additional material 108 may be located within the gap 106 between the nuclear fuel pellets 102 and the cladding 104. In some embodiments, the additional material 108 may be referred to as a “fuel-cladding gap-maintaining material” or simply as a “gap-maintaining material.” The additional material 108 may be formulated and configured to exhibit one or more desired properties, such as one or more desired thermal properties, rheological properties, corrosion resistance properties, and structural properties.

In some embodiments, the additional material 108 comprises a non-radioactive material. In some embodiments, the additional material 108 comprises a different material composition than the nuclear fuel pellets 102 and the cladding 104.

In some embodiments, the additional material 108 comprises a relatively high thermal conductivity and is configured to facilitate thermal transfer from the nuclear fuel pellets 102 to the cladding 104. In some embodiments, the additional material 108 exhibits a thermal conductivity greater than a thermal conductivity of the nuclear fuel pellets 102. By way of non-limiting example, in some such embodiments, the additional material 108 may be formed of and include a ceramic material (e.g., beryllium oxide (BeO), silicon dioxide (SiO₂) titanium dioxide (TiO₂), zirconium oxide (ZrO₂), aluminum oxide (Al₂O₃), calcium oxide (CaO), magnesium oxide (MgO), strontium oxide (SrO), yttrium oxide (Y₂O₃), dysprosium titanate oxide (e.g., Dy₂TiO₅, Dy₂Ti₂O₇), ceramic nitrides (e.g., titanium nitride (TiN), titanium aluminum nitride (TiAlN), zirconium nitride (ZrN), hafnium nitride (HfN), silicon nitride (Si₃N₄), silicon aluminum oxynitride (SiAlON), aluminum nitride (AlN)), ceramic carbides (e.g., silicon carbide (SiC), boron carbide (B₄C), zirconium carbide (ZrC), hafnium carbide (HfC), titanium aluminum carbide (Ti₂AlC), chromium aluminum carbide (Cr₂AlC)), an alloy of chromium and zirconium (CrZr, such as chromium coated zirconium), an alloy of chromium and aluminum (CrAl), magnesium aluminate (MgAl₂O₄), zirconolite (CaZrTi₂O₇), A₂B₂O₇ materials (e.g., La₂Hf₂O₇, La₂Zr₂O₇, La₂Ti₂O₇, Lu₂Ti₂O₇, Gd₂Ti₂O₇, Yb₂Ti₂O₇, Tm₂Ti₂O₇, La₍₂₋ₓ₎GdₓHf₂O₇, Nd₂Zr₂O₇, La₍₂₋ₓ₎GdₓZr₂O₇, La₍₂₋ₓ₎LuₓZr₂O₇, Lu₂Ti₂O₇, La₂Sn₂O₇, Y₂Sn₂O₇, Lu₂Sn₂O₇, Gd₂Sn₂O₇), a zeolite material), aluminum, gold, copper, chromium, nickel, iron, tin, zirconium, hafnium, titanium, tungsten, rhenium, vanadium, chromium, iridium, osmium, ruthenium, niobium, molybdenum, tantalum, sodium, potassium, and a carbon-containing material (e.g., graphite). In some embodiments, the additional material 108 comprises a metal having a melting temperature greater than about 1,500° C., such as greater than about 2,000° C., greater than about 2,500° C., or greater than about 3,000° C.

In some embodiments, the additional material 108 exhibits corrosion resistance and may be formed of and include, for example, a fission barrier material such as one or more of zirconium, vanadium, aluminum, carbon, tin, aluminum oxide, zirconium oxide, silicon carbide, titanium aluminum carbide, chromium aluminum carbide, titanium nitride, titanium aluminum nitride, an alloy of chromium and zirconium, and an alloy of chromium and aluminum. In some embodiments, the additional material 108 comprises one or more of the materials described above with reference to the cladding 104.

In some embodiments, the additional material 108 comprises a material exhibiting a negative Poisson's ratio (the negative transverse strain divided by the longitudinal strain) and/or may exhibiting a geometry such that the additional material 108 exhibits a negative Poisson's ratio. In some such embodiments, the additional material 108 may be referred to as an “auxetic” material. In other words, the additional material 108 may be configured to exhibiting an increase in a dimension (e.g., thickness) in a first direction when stretched in a second direction perpendicular to the first direction (e.g., configured to exhibit a larger axial dimension when stretched in the longitudinal direction). Stated another way, in some embodiments, the additional material 108 may be formulated and configured to exhibit lateral expansion when longitudinally stretched and may become thinner when longitudinally compressed. Accordingly, a volume of the auxetic material may increase responsive to an applied compressive force.

In some embodiments, the additional material 108 may be sized and shaped to be auxetic. In other words, the geometry of the additional material 108 may be tailored to exhibit auxetic properties. In some embodiments, the additional material 108 comprises an open auxetic mechanical structure. By way of non-limiting example, in some embodiments, the additional material 108 exhibits a herringbone shape or a reentrant honeycomb shape.

FIG. 1C is a simplified cross-sectional view illustrating an auxetic structure 150 including a repeating pattern of cells 152. In some embodiments, laterally neighboring cells 152 are longitudinally offset (e.g., in the Z-direction) from each other by about one-half a cell length. Accordingly, a longitudinal center of each cell 152 of a particular column 154 of cells 152 may be aligned with top and bottom ends of laterally neighboring (e.g., in X-direction) cells 152 in laterally neighboring columns 154. Each of the cells 152 includes side walls 156 that are laterally oriented inwards towards a longitudinal axis at a longitudinal center of the respective cell 152 at a longitudinal center of the respective cell 152. When the cells 152 are exposed to stretching in the longitudinal direction, the side walls 156 of each cell 152 may change from an angled orientation to a substantially linear orientation with substantially parallel side walls 156, increasing the volume of the auxetic structure 150 in the longitudinal direction and the direction transverse (e.g., in the X-direction) to the longitudinal direction.

In some embodiments, the auxetic material may comprise a monostable auxetic material. In some such embodiments, the auxetic material is configured to return to its initial size, shape, and geometry upon removal of the applied force from the monostable auxetic material. In other embodiments, the auxetic material comprises a bistable auxetic material. In some such embodiments, the bistable auxetic material exhibits two stable positions and may switch between the two stable positions depending on an applied load to the bistable auxetic material. In some embodiments, after removal of the applied force, the bistable auxetic material may retain the shape to which the bistable auxetic material switched during application of the applied force.

By way of non-limiting example, the auxetic additional materials 108 may include auxetic polyurethane foam, molybdenum disulfide (MoS₂), barium sulfate (BaSO₄), graphene including vacancy defects, carbon diamond-like phases, noncarbon nanotubes, and some forms of polytetrafluoroethylene polymers (e.g., Gore-Tex). In some embodiments, the additional material 108 comprises a ceramic auxetic material, such as one or more aluminum oxide, zirconium oxide, silicon carbide, titanium aluminum carbide (Ti₂AlC), chromium aluminum carbide (Cr₂AlC).

In some embodiments, the additional material 108 exhibits a substantially homogeneous (e.g., uniform) composition. In other embodiments, the additional material 108 exhibits a heterogeneous composition including more than one material. In some such embodiments, a composition of the additional material 108 may vary with, for example, a distance from the longitudinal axis 105 of the fuel rod 100. By way of non-limiting example, in some embodiments, the additional material 108 comprises a first material composition and a second material composition. A concentration of the first material composition may decrease with an increasing radial distance from the longitudinal axis 105 and a concentration of the second material composition may increase with an increasing radial distance from the longitudinal axis 105.

In some embodiments, one or more of a void fraction, a pore size, and a density of the additional material 108 may be tailored to form the additional material 108 to exhibit desired rheological properties through the additional material 108. In some embodiments, increasing the void fraction decreases the pressure drop through the additional material 108 and, therefore, increases the flowrate of materials (e.g., one or more gases, one or more liquids) through the additional material 108 for a given pressure drop. In some embodiments, increasing the pore size of the additional material 108 increases the flowrate of a material through the additional material 108.

A void fraction of the additional material 108 may be within a range of from about 0.10 to about 0.90, such as from about 0.10 to about 0.20, from about 0.20 to about 0.30, from about 0.30 to about 0.40, from about 0.40 to about 0.50, from about 0.50 to about 0.60, from about 0.60 to about 0.70, from about 0.70 to about 0.80, or from about 0.80 to about 0.90.

A median pore size of the additional material 108 may be substantially unimodal (e.g., having one peak of pore size). In other embodiments, the median pore size of the additional material 108 may exhibit a polymodal distribution, such as a bimodal distribution or a trimodal distribution of median pore sizes. The median pore size may be within a range of from about 1.0 μm to about 5.0 mm, such as from about 1.0 μm to about 5.0 μm, from about 5.0 μm to about 10.0 μm, from about 10.0 μm to about 50.0 μm, from about 50.0 μm to about 100 μm, from about 100 μm to about 200 μm, from about 200 μm to about 500 μm, from about 500 μm to about 1.0 mm, from about 1.0 mm to about 2.0 mm, or from about 2.0 mm to about 5.0 mm.

A density of the additional material 108 may be within a range of from about 5.0 g/cm³ to about 10.0 g/cm³, such as from about 5.0 g/cm³ to about 6.0 g/cm³, from about 6.0 g/cm³ to about 7.0 g/cm³, from about 7.0 g/cm³ to about 8.0 g/cm³, from about 8.0 g/cm³ to about 9.0 g/cm³, or from about 9.0 g/cm³ to about 10.0 g/cm³. In some embodiments, the density of the additional material 108 is within a range of from about 6.0 g/cm³ to about 7.0 g/cm³. However, the disclosure is not so limited and the density of the additional material 108 may be different than that described.

In other embodiments, and as described in further detail below, the additional material 108 may be formed of and include a sacrificial material formulated and configured to be selectively removed from the fuel rod 100 relative to the nuclear fuel pellets 102 and the cladding 104.

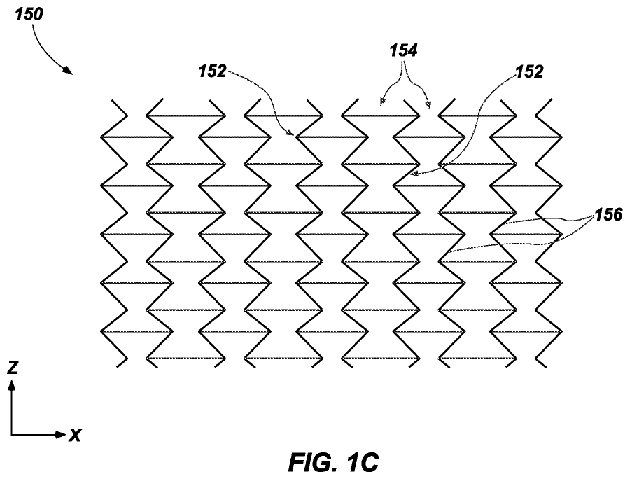

FIG. 2A is a simplified cross-sectional view of a fuel rod 200, in accordance with additional embodiments of the disclosure. FIG. 2B is a simplified partial cross-sectional view of the fuel rod 200 taken through section line B-B of FIG. 2A. With collective reference to FIG. 2A and FIG. 2B, the fuel rod 200 may be substantially similar to the fuel rod 100 described above with reference to FIG. 1A and FIG. 1B, except that the fuel rod 200 includes an additional material 208 in a gap 206 between the nuclear fuel pellets 102 and the cladding 104 rather than the additional material 108. In some embodiments, the additional material 208 comprises a different material than the additional material 108 (FIG. 1A, FIG. 1B) and/or exhibits a different geometry than the additional material 108.

In some embodiments, the additional material 208 comprises a randomly dispersed network of wire 212. By way of non-limiting example, the wire 212 of the additional material 208 may exhibit a shape and configuration similar to that of steel wool and may include, for example, coils of wire 212. In some embodiments, the wire 212 may comprise a substantially continuous (e.g., integral) member. In some embodiments, the gap 206 may include more than one continuous members of the wire 212. In some embodiments, the wire 212 may be formed to including a plurality of coils neighboring one another.

In some embodiments, a cross-sectional dimension (e.g., diameter) of the wire 212 taken in a direction perpendicular to the longitudinal axis of the wire 212 (e.g., in a direction perpendicular to the longitudinal axis of the wire 212 when the wire 212 is stretched out) may be within a range of from about 25 μm (about 0.025 mm) to about 200 μm (about 0.200 mm), such as from about 25 μm to about 50 μm, from about 50 μm to about 75 μm, from about 75 μm to about 100 μm, from about 100 μm to about 150 μm, or from about 150 μm to about 200 μm.

In some embodiments, the additional material 208 comprising the wire 212 may act as a so-called “thermal wick” and may be configured to facilitate thermal transfer of heat from the nuclear fuel pellets 102 to the cladding 104 and away from the fuel rod 200. In some embodiments, the porosity of the additional material 208 may facilitate flow of one or more materials (e.g., one or more gases, one or more liquids) through the gap 206. In some embodiments the porosity of the additional material 208 may be greater than the porosity of the additional material 108 (FIG. 1A, FIG. 1B). By way of non-limiting example, the porosity of the additional material 208 may be within a range of from about 80 and about 95, such as from about 80 to about 85, from about 85 to about 90, or from about 90 to about 95. Stated another way, in some embodiments, from about 5 volume percent to about 20 volume percent of the gap 206 may be filled with the additional material 208.

The additional material 208 may be formed of and include one or more of the materials described above with reference to the additional material 108. For example, the additional material 208 may include one or more of a ceramic material (e.g., beryllium oxide (BeO), silicon dioxide (SiO₂) titanium dioxide (TiO₂), zirconium oxide (ZrO₂), aluminum oxide (Al₂O₃), calcium oxide (CaO), magnesium oxide (MgO), strontium oxide (SrO), yttrium oxide (Y₂O₃), dysprosium titanate oxide (e.g., Dy₂TiO₅, Dy₂Ti₂O₇ ), ceramic nitrides (e.g., titanium nitride (TiN), titanium aluminum nitride (TiAlN), zirconium nitride (ZrN), hafnium nitride (HfN), silicon nitride (Si₃N₄), silicon aluminum oxynitride (SiAlON), aluminum nitride (AlN)), ceramic carbides (e.g., silicon carbide (SiC), boron carbide (B₄C), zirconium carbide (ZrC), hafnium carbide (HfC), titanium aluminum carbide (Ti₂AlC), chromium aluminum carbide (Cr₂AlC)), an alloy of chromium and zirconium (CrZr, such as chromium coated zirconium), an alloy of chromium and aluminum (CTAl), magnesium aluminate (MgAl₂O₄), zirconolite (CaZrTi₂O₇), A₂B₂O₇ materials (e.g., La₂Hf₂O₇, La₂Zr₂O₇, La₂Ti₂O₇, Lu₂Ti₂O₇, Gd₂Ti₂O₇, Yb₂Ti₂O₇, Tm₂Ti₂O₇, La₍₂₋ₓ₎GdₓHf₂O₇, Nd₂Zr₂O₇, La₍₂₋ₓ₎GdₓZr₂O₇, La₍₂₋ₓ₎LuₓZr₂O₇, Lu₂Ti₂O₇, La₂Sn₂O₇, Y₂Sn₂O₇, Lu₂Sn₂O₇, Gd₂Sn₂O₇), a zeolite material), aluminum, gold, copper, chromium, nickel, iron, tin, zirconium, hafnium, titanium, vanadium, niobium, molybdenum, tantalum, sodium, potassium, and a carbon-containing material (e.g., graphite).

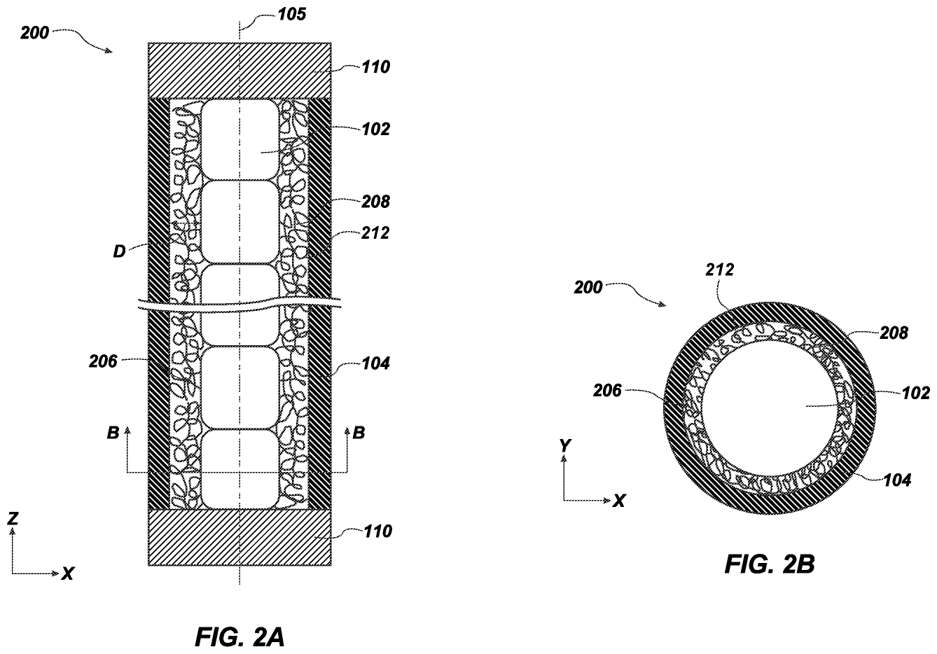

FIG. 3A is a simplified cross-sectional view of a fuel rod 300, in accordance with additional embodiments of the disclosure. FIG. 3B is a simplified partial cross-sectional view of the fuel rod 300 taken through section line B-B of FIG. 3A. With collective reference to FIG. 3A and FIG. 3B, the fuel rod 300 may be substantially similar to the fuel rod 100 described above with reference to FIG. 1A and FIG. 1B, except that the fuel rod 300 does not include the additional material 108 and includes thermal transfer structures 308 (also referred to herein as “whiskers” or “rods”) in a gap 306 between the nuclear fuel pellets 102 and the cladding 104. In some embodiments, the thermal transfer structures 308 comprise a different material than the additional material 108 (FIG. 1A, FIG. 1B) and/or a different geometry than the additional material 108.

With collective reference to FIG. 3A and FIG. 3B, the thermal transfer structures 308 may extend (e.g., span) through the gap 306 from the nuclear fuel pellets 102 to the cladding 104 and may be in thermal communication with (e.g., contact with) the nuclear fuel pellets 102 and the cladding 104.

The thermal transfer structures 308 may comprise cylindrical structures (e.g., rods) extending from the nuclear fuel pellets 102 to the cladding 104. In some embodiments, the thermal transfer structure 308 may be arranged such that longitudinal axes thereof are substantially parallel with each other when viewed in the cross-section illustrated in FIG. 3A.

In some embodiments, an angle θ between a longitudinal axis 309 of the thermal transfer structures 308 and a longitudinal axis 105 (corresponding to the sidewall of the nuclear fuel pellets 102) of the fuel rod 300 may be within a range of from about 10° to about 90°, such as from about 10° to about 30°, from about 30° to about 45°, from about 45° to about 60°, from about 60° to about 75°, or from about 75° to about 90°. In some embodiments, the angle θ is about 90°. In some such embodiments, the thermal transfer structures 308 are oriented substantially perpendicular to the fuel rod 300. In other words, the longitudinal axis 309 of each individual thermal transfer structure 308 is substantially perpendicular to the longitudinal axis 105 of the fuel rod 300.

In other embodiments, at least some of the thermal transfer structures 308 may be oriented at different angles θ as the other thermal transfer structures 308. In other words, at least some of the thermal transfer structure 308 may be oriented at a different angle θ than at least other thermal transfer structures 308.

In some embodiments, each of the thermal transfer structures 308 comprise substantially the same material composition. In other embodiments, at least some of the thermal transfer structures 308 comprise a different material composition than at least others of the thermal transfer structure 308.

The thermal transfer structures 308 may individually be formed of and include one or more of that materials described above with reference to the additional material 108. By way of non-limiting example, the thermal transfer structures 308 may be formed of and include one or more of the materials described above with reference to the additional material 108. In some embodiments, the thermal transfer structures 308 comprise one or more ceramic materials, such as one or more of beryllium oxide (BeO), silicon dioxide (SiO₂) titanium dioxide (TiO₂), zirconium oxide (ZrO₂), aluminum oxide (Al₂O₃), calcium oxide (CaO), magnesium oxide (MgO), strontium oxide (SrO), yttrium oxide (Y₂O₃), dysprosium titanate oxide (e.g., Dy₂TiO₅, Dy₂Ti₂O₇ ), ceramic nitrides (e.g., titanium nitride (TiN), titanium aluminum nitride (TiAlN), zirconium nitride (ZrN), hafnium nitride (HfN), silicon nitride (Si₃N₄), silicon aluminum oxynitride (SiAlON), aluminum nitride (AlN)), ceramic carbides (e.g., silicon carbide (SiC), boron carbide (B₄C), zirconium carbide (ZrC), hafnium carbide (HfC), titanium aluminum carbide (Ti₂AlC), chromium aluminum carbide (Cr₂AlC)), an alloy of chromium and zirconium (CrZr, such as chromium coated zirconium), an alloy of chromium and aluminum (CrAl), magnesium aluminate (MgAl₂O₄), zirconolite (Ca₇rTi₂O₇ ), and A₂B₂O₇ materials (e.g., La₂Hf₂O₇, La₂Zr₂O₇, La₂Ti₂O₇, Lu₂Ti₂O₇, Gd₂Ti₂O₇, Yb₂Ti₂O₇, Tm₂Ti₂O₇, La₍₂₋ₓ₎GdₓHf₂O₇, Nd₂Zr₂O₇, La₍₂₋ₓ₎GdₓZr₂O₇, La₍₂₋ₓ₎LuₓZr₂O₇, Lu₂Ti₂O₇, La₂Sn₂O₇, Y₂Sn₂O₇, Lu₂Sn₂O₇, Gd₂Sn₂O₇ ).

In some embodiments, the thermal transfer structures 308 are disposed in a matrix material 312 within the gap 306. The matrix material 312 may be formed of and include, for example, one or more of the materials described above with reference to the additional material 108 and the additional material 208. In some embodiments, the matrix material 312 comprises a different material composition than the thermal transfer structures 308.

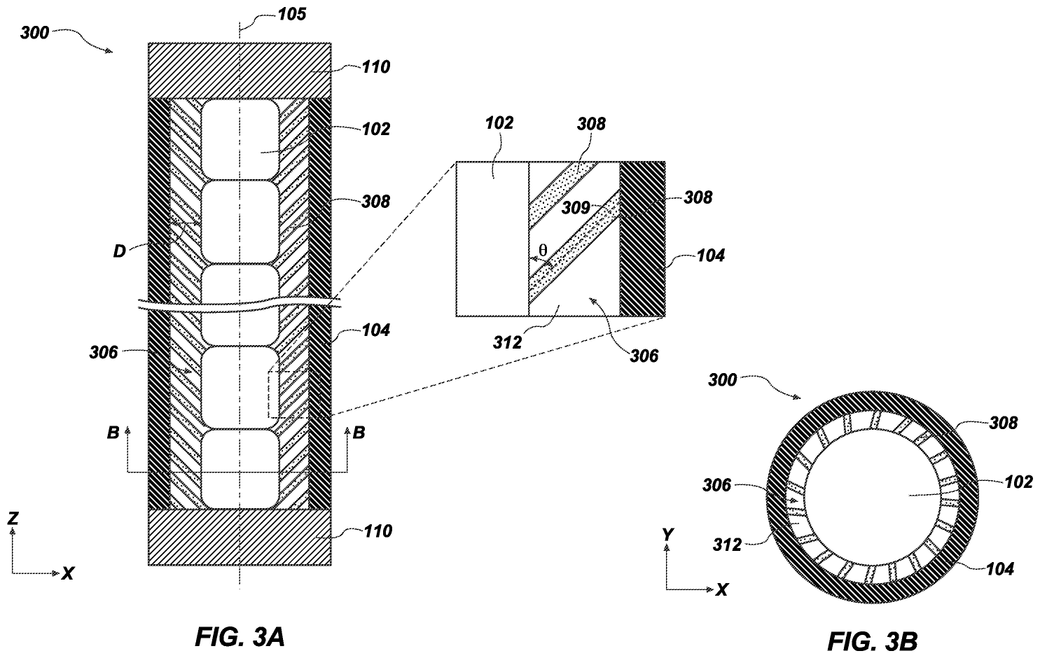

FIG. 4A is a simplified cross-sectional view of a fuel rod 400, in accordance with additional embodiments of the disclosure. FIG. 4B is a simplified partial cross-sectional view of the fuel rod 400 taken through section line B-B of FIG. 4A. With collective reference to FIG. 4A and FIG. 4B, the fuel rod 400 may be substantially similar to the fuel rod 100 described above with reference to FIG. 1A and FIG. 1B, except that the fuel rod 400 does not include the additional material 108, but includes an additional material 408 in a gap 406 between the nuclear fuel pellets 102 and the cladding 104. In some embodiments, the additional material 408 comprises a different material than the additional material 108 (FIG. 1A, FIG. 1B) and/or may exhibit a different geometry than the additional material 108.

The additional material 408 may comprise a foam material, such as an open cell foam material or a closed cell foam material. In some embodiments, the additional material 408 comprise an open cell foam, such as, for example, polyurethane or reticulated polyurethane.

FIG. 4C is an enlarged cross-sectional view of an additional material 408 comprising an open cell foam material. In some embodiments, the open cell foam material exhibits an open porosity such that material may flow from one end of the open cell foam material (e.g., from a location proximate a first end cap 110 (FIG. 4A)) to an opposite end of the open cell foam material (e.g., to a location proximate a second, opposite end cap 110 (FIG. 4A)).

In some embodiments, the additional material 408 exhibits a density within a range of from about 0.10 g/cm³ to about 0.40 g/cm³ such as from about 0.10 g/cm³ to about 0.20 g/cm³, from about 0.20 g/cm³ to about 0.30 g/cm³, or from about 0.30 g/cm³ to about 0.40 g/cm³.

In some embodiments, the additional material 408 may comprise an open cell structure such that fluids within the gap 406 may flow between an upper end of the fuel rod 400 (e.g., from the upper end cap 110) and the lower end of the fuel rod 400 (e.g., from the lower end cap 110). In some embodiments, the additional material 408 is shaped to form one or more channels extending along the longitudinal axis 105 of the fuel rod 400 and configured to facilitate the flow of fluid through the channels. In other words, the additional material 408 may define one or more channels to facilitate flow of material along the longitudinal axis 105 of the fuel rod 400.

As will be described herein, each of the fuel rods 100, 200, 300, 400 may be formed by additive manufacturing techniques, or more be formed by conventional fabrication techniques.

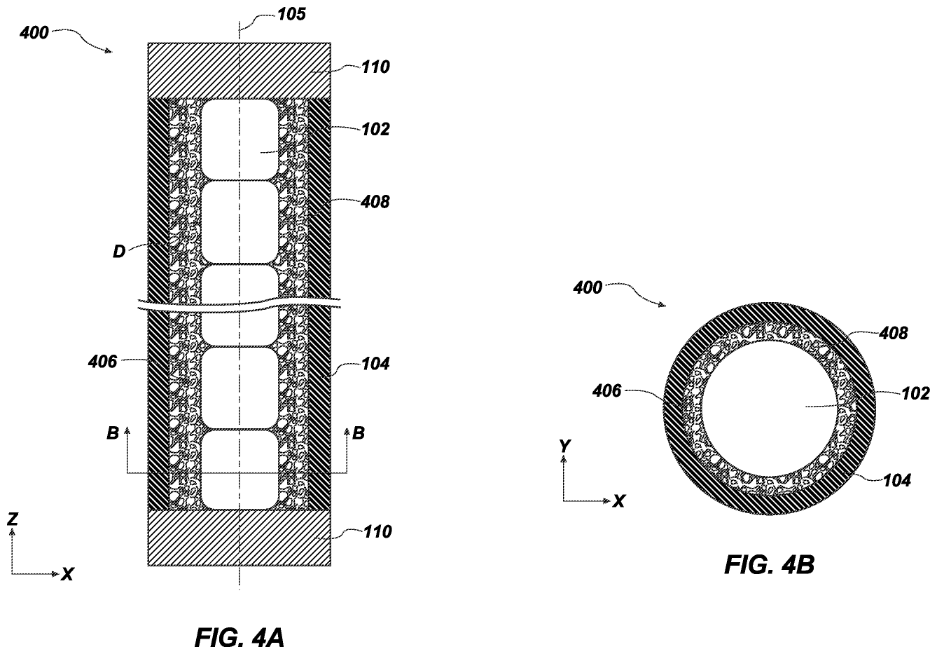

FIG. 5 is a simplified schematic illustrating a system 500 for forming one or structures, in accordance with embodiments of the disclosure. In some embodiments, the structures 502 formed by the system 500 comprises one or more portions (e.g., an entirety of) the fuel rods 100, 200, 300, 400 previously described. Accordingly, the system 500 may be used to form the fuel rods 100, 200, 300, 400, or at least a portion thereof. The system 500 may comprise a digit light processing (DLP) system for additively manufacturing the structure 502.

The system 500 comprises a projector 504 configured to project electromagnetic radiation (e.g., light, visible light, ultraviolet light) 506 onto a substrate 508. The substrate 508 may comprise a film or other material that is optically transparent to the electromagnetic radiation 506. In some embodiments, the electromagnetic radiation 506 comprises ultraviolet (UV) light (electromagnetic radiation in the ultraviolet spectrum).

In some embodiments, the substrate 508 comprises polyethylene terephthalate such as MYLAR® available from DuPont Teijin Films. A resin 510 may be disposed over the substrate 508. The resin 510 may comprise a photo-polymerizing (e.g., light-polymerizing) material and may include one or more materials from which the structure 502 is formed dispersed within the photo-polymerizing material. The one or more materials from which the structure 502 is formed may be in a powder form. The photo-polymerizing material may comprise any photocurable resin, such as one or more of propylene fumarate, diethyl fumarate, a thermoset polyurethane, and bisacrylphosphine oxide. In some embodiments, the photo-polymerizing material comprises a thermosetting resin material.

The powder within the resin 510 may include one or more the materials described above with reference to each of the nuclear fuel pellets 102, the cladding 104, the additional materials 108, 208, 408, and the thermal transfer structures 308.

In use and operation, to form the structure 502, the resin 510 may be provided in an uncured state over the substrate 508. The resin 510 provided on the substrate 508 may have a thickness within a range of from about 20 μm to about 500 μm, such as from about 20 μm to about 50 μm, from about 50 μm to about 100 μm, from about 100 μm to about 200 μm, from about 200 μm to about 300 μm, or from about 300 μm to about 500 μm.

With continued reference to FIG. 5, a build plate 512 may be disposed over the resin 510. During formation of the structure 502, the build plate 512 may be brought into contact with the resin 510 and the resin 510 may be exposed to the electromagnetic radiation 506 to at least partially cure (e.g., photopolymerize, form cross-links) the resin 510 and form the structure 502. The shape of the electromagnetic radiation 506 projected onto the substrate 508 may be tailored to the desired shape of the layer of the structure 502 being formed. As the resin 510 cures, the structure 502 attaches to (e.g., is formed on) the build plate 512.

Additional layers (e.g., segments) may be formed on previously formed layers of the structure 502. In some embodiments, a distance of the build plate 512 from the substrate 508 may be increased by raising the build plate 512 and/or lowering the substrate 508 to increase the relative distance between the build plate 512 and the substrate 508. In some embodiments, an additional layer of the resin 510 is brought into contact with the substrate 508 and exposed to the electromagnetic radiation 506 to form an additional layer of the structure 502. In some embodiments, between forming layers of the structure 502, the resin 510 may be exchanged, the composition of the resin 510 may be altered, or both. The previously formed layer of the structure 502 may be brought into contact with the resin 510 and the resin 510 is at least partially cured on the previously formed structure 502. The process of providing and curing the resin 510 may be repeated until the structure 502 is formed to a desired dimension.

Accordingly, a structure 502 having a desired size, shape, geometry, and composition may be formed layer by layer with the system 500. In addition, each layer of the structure 502 may be formed to exhibit a different composition by changing the composition of the resin 510 during additive manufacturing of the structure 502.

In some embodiments, the structure 502 may be exposed to additional processes to solidify and/or continue polymerization of the resin 510. By way of non-limiting example, the structure 502 may be irradiated with a gamma radiation source, such as cobalt-60 radiation. The structure 502 may also be subject to annealing conditions to densify the structure 502 and/or remove the resin material 510 from the structure 502 such that the remaining portions of the structure 502 comprise, for example, a fuel rod 100, 200, 300, 400, or at least a portion thereof.

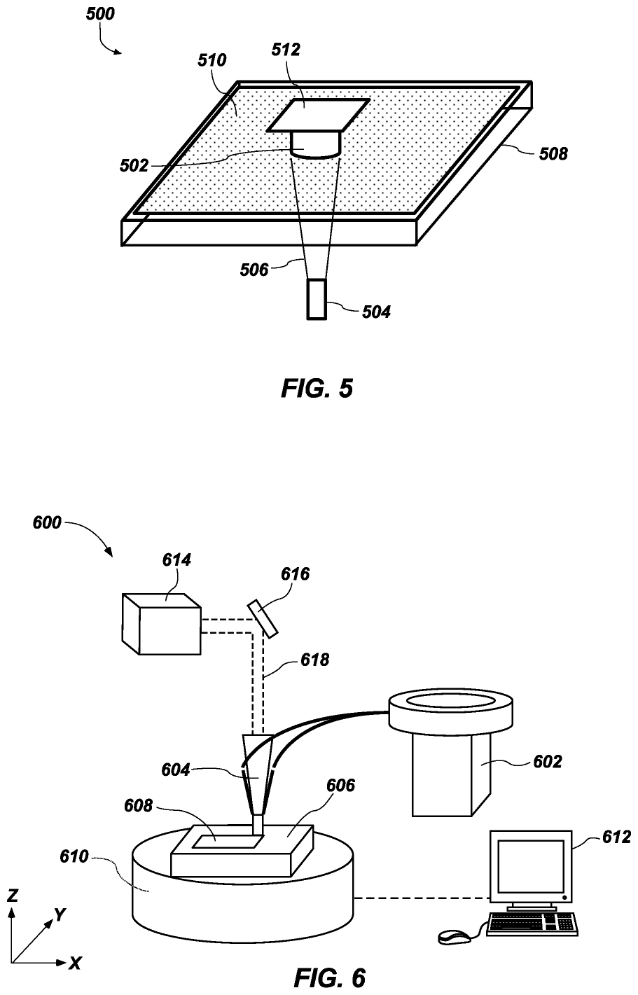

FIG. 6 is a simplified schematic of a system 600 for additively manufacturing one or more structures 608, in accordance with additional embodiments of the disclosure. In some embodiments, the structures 608 formed by the system 600 comprise one or more portions (e.g., an entirety of) the fuel rods 100, 200, 300, 400 previously described. Accordingly, the system 600 may be used to form the fuel rods 100, 200, 300, 400, or at least a portion thereof. In some embodiments, the system 600 comprises a selective laser sintering (SLS) system.

The system 600 includes a powder feed 602 comprising sources of one or more powder constituents used to form the structure 608 being additively manufactured. The powder feed 602 may comprise particles of one or more components of the structure 608 being formed, such as particles of one or more components of the fuel rods 100, 200, 300, 400. By way of non-limiting example, the powder feed 602 may include particles of the nuclear fuel pellets 102, the cladding 104, and one of the additional materials 108, 208, 408, and thermal transfer structures 308.

The powder feed 602 may be in fluid communication with a powder delivery nozzle 604. The powder feed 602 may be provided to the powder delivery nozzle 604 as a mixture of components of nuclear fuel materials (e.g., the nuclear fuel pellets 102), cladding materials (e.g., materials of the cladding 104), and additional materials (e.g., additional materials 108, 208, 408, thermal transfer structures 308). In other embodiments, the powder feed 602 may be provided to the powder delivery nozzle 604 as separate components (e.g., the nuclear fuel material, the cladding material, the additional material) that are mixed at the powder delivery nozzle 604.

The powder delivery nozzle 604 may be positioned and configured to deliver the powder feed 602 to a surface of a substrate 606 on which the structure 608 is formed. The powder delivery nozzle 604 may be configured to deliver more than one powder feed 602 composition to the substrate 606 concurrently. In other words, the powder delivery nozzle 604 may be in fluid communication with powders having more than one composition and may be used to form the structure 608 having one or more different composition therethrough. Accordingly, although only one powder delivery nozzle 604 is illustrated in FIG. 6, in some embodiments, the system 600 includes more than one powder delivery nozzle 604, each powder delivery nozzle 604 in fluid communication with a powder feed 602 having a different composition than the other powder delivery nozzles 604. By way of nonlimiting example, in some embodiments, the system 600 includes a powder delivery nozzle 604 in fluid communication with a powder feed 602 comprising a nuclear fuel material, a powder delivery nozzle 604 in fluid communication with a powder feed 602 comprising a cladding material, and a powder delivery nozzle 604 in fluid communication with a powder feed 602 comprising an additional material.

In other embodiments, the powder delivery nozzle 604 may be in fluid communication with a plurality of powder feed 602 materials. In some such embodiments, the powder delivery nozzle 604 is configured to receive powder from different powder feed 602 materials and configured to dispose powders of different compositions on the substrate 606.

The substrate 606 and the structure 608 are disposed on a table 610, which may comprise, for example, a triaxial numerical control machine. Accordingly, the table 610 may be configured to move along at least three axes. By way of nonlimiting example, the table 610 may be configured to move in the x-direction (i.e., left and right in the view illustrated in FIG. 6), the y-direction (i.e., into and out of the page in the view illustrated in FIG. 6), and the z-direction (i.e., up and down in the view illustrated in FIG. 6).

The table 610 may be operably coupled with a central processing unit 612 configured to control the table 610. In other words, movement of the table 610 may be controlled through the central processing unit 612, which may comprise a control program for a processor including operating instructions for movement of the table 610.

The system 600 may further include an energy source 614 configured to provide energy to the powder on the substrate 606. Energy (e.g., electromagnetic energy) from the energy source 614 may be directed to the substrate 606 and the structure 608 through a mirror 616, which may orient the energy to the substrate 606. The energy source 614 may comprise, for example, a laser (e.g., selective laser additive manufacturing), an electron beam, a source of microwave energy, or another energy source. In some embodiments, powder from the powder delivery nozzle 604 is disposed on the substrate 606 and simultaneously exposed to energy (illustrated by broken lines 618) from the energy source 614.

Although FIG. 6 illustrates that the table 610 is operably coupled with the central processing unit 612 to effect movement of table 610, the disclosure is not so limited. In other embodiments, the central processing unit 612 is operably coupled with the powder delivery nozzle 604 and the energy source 614 and the powder delivery nozzle 604 and the energy source 614 is configured to move in one or more directions (e.g., the x-direction, the y-direction, and the z-direction) responsive to receipt of instructions from the central processing unit 612. In some such embodiments, one or some of the powder delivery nozzle 604, the energy source 614 and the table 610 may be configured to move in one or more directions. Movement of the powder delivery nozzle 604, the energy source 614, the table 610, or both may facilitate forming the structure 608 to have a desired composition and geometry.

In use and operation, a layer of powder from the powder feed 602 and expelled by the powder delivery nozzle 604 may be formed over the substrate 606 and subsequently exposed to energy from the energy source 614 to form inter-granular bonds between particles of the layer of powder. In other embodiments, the powder is exposed to energy from the energy source 614 substantially simultaneously with delivery of the powder to the surface of the substrate 606 or substantially immediately thereafter. In some such embodiments, portions of the layer of the structure 608 being formed may be exposed to energy from the energy source 614 prior to formation of the entire layer of the structure 608. At least one of the energy source 614 and the table 610 may be configured to move responsive to instructions from the central processing unit 612.

After formation of the layer of the structure 608, the substrate 606 is moved away from the energy source 614, such as by movement of one or both of the table 610 and the energy source 614 responsive to receipt of instructions from the central processing unit 612. Additional powder may be delivered to the surface of the previously formed layer of the structure 608 in a desired pattern and exposed to energy from the energy source 614 to form inter-granular bonds between adjacent particles of the powder in the layer and between particles of the powder in the layer and the underlying layer of the structure 608.

Each layer of the structure 608 may be between about 25 μm (about 0.001 inch) and about 500 μm (about 0.020 inch), such as between about 25 μm and about 50 μm, between about 50 μm and about 100 μm, between about 100 μm and about 200 μm, between about 200 μm and about 300 μm, between about 300 μm and about 400 μm, or between about 400 μm and about 500 μm. Accordingly, the structure 608 may be formed one layer at a time, each layer having a thickness between about 25 μm and about 500 μm.

In some embodiments, one or more layers of the structure 608 may be formed to exhibit a different composition than one or more other layers of the structure 608. In some embodiments, different portions of a single layer of the structure 608 may exhibit a different composition than other portions of the same layer of the structure 608. By way of nonlimiting example, where the structure 608 comprises a fuel rod, a portion (i.e., a central portion) of the layer may comprise a nuclear fuel material (e.g., the nuclear fuel pellets 102), a portion surrounding the nuclear fuel material may comprise an additional material (e.g., the additional material (e.g., the additional material 108, 208, 408, the thermal transfer structure 308)), and a portion surrounding the additional material may comprise a cladding material (e.g., a material of the cladding 104). In some embodiments, the fuel rods 100, 200, 300, 400 may be formed by forming first layers of the cladding 104 and the end caps 110; forming second layers comprising the end caps 110 and the additional material (e.g., the additional material 108, the additional material 208, the thermal transfer structures 308, or the additional material 408) over the first layers; forming third layers comprising the end caps 110 and the nuclear fuel pellets 102 over the second layers; forming fourth layers comprising the end caps 110 and the additional material over the third layers; and forming fifth layers comprising the cladding 104 and the end caps 110 over the fourth layers.

In some embodiments, a magnetic field may be applied to one or more of the structure 608, the substrate 606, and the table 610 during fabrication of the structure 608. Application of the magnetic field may facilitate alignment of one or more components of the structure 608 during fabrication thereof. By way of non-limiting example, in some embodiments, such as when forming a fuel rod 300 comprising the thermal transfer structures 308, application of the magnetic field during fabrication of the thermal transfer structures 308 may facilitate alignment of the thermal transfer structures 308.

Although FIG. 5 and FIG. 6 have been described and illustrated as including a respective DLP additive manufacturing system 500 and a selective laser sintering additive manufacturing system 600, the disclosure is not so limited. In other embodiments, the additive manufacturing system 600 may include binder jet additive manufacturing, stereolithography, powder bed fusion (e.g., direct metal laser sintering, selective heat sintering, electron beam melting, direct metal laser melting), direct energy deposition, material extrusion, or sheet lamination (e.g., laminated object manufacturing, ultrasonic additive manufacturing).

Although the fuel rods 100, 200, 300, 400 have been described and illustrated as including the respective additional material 108, additional material 208, thermal transfer structures 308, and additional material 408, the disclosure is not so limited. In other embodiments, and as previously described with reference to FIG. 1A and FIG. 1B, the additional material 108 comprise a sacrificial material formulated and configured to be selectively removed relative to other components of the fuel rod 100 (e.g., the nuclear fuel pellets 102 and the cladding 104).

The sacrificial material may include one or more materials formulated and configured to be selectively removed responsive to exposure to one or more of an acid, a solvent, electromagnetic radiation with respect to the other components of the fuel rod 100. By way of non-limiting example, the sacrificial material may be formed of and include silicon nitride, silicon dioxide, a photosensitive material (e.g., photomask materials, a photosensitive glass material, and a photoresist material (e.g., a positive photoresist material, a negative photoresist material, a photopolymeric material (e.g., methyl methacrylate))), a photodecomposition material (e.g., an azide quinone, such as diazoapthaquinone (DQ), a photocrosslinking material). In some embodiments, the sacrificial material comprise silicon nitride.

After forming the fuel rod 100 including the additional material 108 comprising the sacrificial material, the sacrificial material may be treated with (e.g., exposed to) one or more of an acid (e.g., nitric acid, sulfuric acid, phosphoric acid, hydrochloric acid), a solvent (e.g., ammonium hydroxide, potassium hydroxide), electromagnetic radiation to selectively remove the sacrificial material from the fuel rod 100. In some such embodiments, the gap 106 may be substantially free of the additional material 108.

In some embodiments, at least a portion of the sacrificial material interacts with (e.g., chemically reacts with, forms a coating on) a portion of the fuel rod 100 during removal of the sacrificial material. In some embodiments, the sacrificial material reacts with the cladding 104 to form a coating on the cladding 104. In other embodiments, the sacrificial material is absorbed by the cladding 104 to enhance properties (e.g., corrosion resistance, abrasion resistance, heat transfer) of the cladding 104.

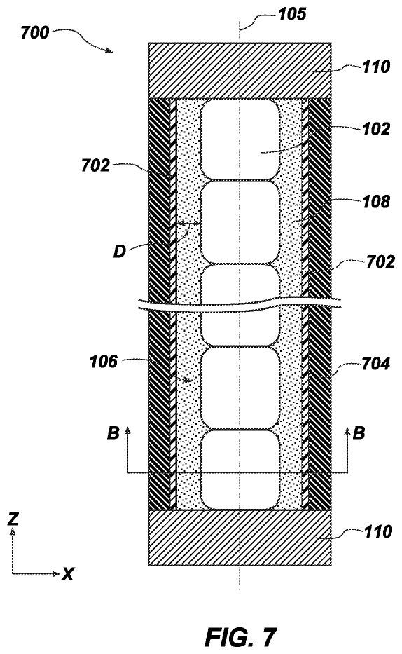

FIG. 7 is a simplified partial cross-sectional view of a fuel rod 700 including a coating formed on the cladding 104, in accordance with embodiments of the disclosure. In some embodiments, the fuel rod 700 is substantially similar to the fuel rod 100 described above with reference to FIG. 1A and FIG. 1B, except that the fuel rod 700 includes a cladding 704 having a different material composition than the cladding 104 and comprises a coating material 702 disposed between the additional material 108 and the inner diameter of the cladding 704. The coating material 702 may comprise, for example, a reaction byproduct of the material of the cladding 104 and the material of the additional material 108. In some embodiments, at least a portion of the cladding 704 comprises one or more materials of the additional material 108 dispersed therein.

One or more of the fuel rods 100, 200, 300, 400, 700 may be used as a component of, for example, a nuclear reactor. Other components of a nuclear reactor in which a gap between adjacent materials may be beneficial may be formed by a similar process.

Although FIG. 5 and FIG. 6 have been described and illustrated as comprising systems 500, 600 configured for forming the fuel rods 100, 200, 300, 400, 700 of FIG. 1A through FIG. 4B and FIG. 7, the disclosure is not so limited. In some embodiments, the systems 500, 600 are configured to form a first material separated from a second material by a third material or other components of an apparatus (e.g., a microchip, a heat exchanger, rocket motors).

Although the additional materials 108, 208, 408, and the thermal transfer structures 308 have been described as comprising materials exhibiting a relatively high thermal conductivity, the disclosure is not so limited. In other embodiments, the additional materials 108, 208, 408, and the thermal transfer structures 308 comprise a thermal barrier material exhibiting a relatively low thermal conductivity. In some embodiments, the additional material 108 may reduce an amount of thermal transfer from a first material to a second material. In some embodiments, the additional material 108 exhibits a thermal conductivity lower than a thermal conductivity of the first material and/or the second material. By way of non-limiting example, the thermal barrier material may include one or more of calcium silicate (2CaO—SiO₂), perlite, fiberglass, and wool fiber. In some such embodiments, the first material comprises a material different than the nuclear fuel pellets 102 and the second material comprises a material different than the cladding 104.

Although the fuel rods 100, 200, 300, 400, 700 have been described and illustrated as being formed by additive manufacturing, the disclosure is not so limited. In other embodiments, the fuel rods may be formed by other fabrication methods. By way of non-limiting example, the fuel rod 300 may be formed by heating an empty cladding 104 (e.g., not including the nuclear fuel pellets 102 or the thermal transfer structures 308); disposing a structure comprising concentric tubes including a matrix material (e.g., the matrix material 312) comprising the thermal transfers structures 308 disposed in an annulus between the concentric tubes in the heated cladding 104; and removing the concentric tubes from the cladding 104 while leaving the matrix material comprising the thermal transfer structures to form the fuel rod 300.

Accordingly, a structure may be formed to include a first material (e.g., nuclear fuel pellets) spaced from a second material (e.g., cladding) by a gap. The gap may comprise one or more of a sacrificial material and one or more of the materials described above with reference to the additional materials 108, 208, 408, and the thermal transfer structures 308. In some embodiments, the material in the gap directly contacts each of the first material and the second material. A distance between the first material and the second material may be maintained by the material within the gap. In some embodiments, the material in the gap facilitates improved thermal transfer from the first material to the second material. In other embodiments, the material in the gap substantially thermally insulates the first material from the second material. In additional embodiments, the material in the gap provides mechanical integrity to the structure.

In some embodiments, forming the fuel rods 100, 200, 300, 400, 700 by additive manufacturing may facilitate direct integrated manufacturing and simultaneous fabrication of the fuel rods including the nuclear fuel pellets 102, the cladding 104, and the additional materials 108, 208, 408 and/or the thermal transfer structures 308. In addition, the additive manufacturing process may facilitate use of more material compositions for one or more of the nuclear fuel pellets 102 and the cladding 104 compared to conventional fabrication methods and may facilitate fabrication of the gap-mainlining materials integral with the fuel rods 100, 200, 300, 400, 700. In some embodiments, the properties of the additional materials 108, 208, 408 and the thermal transfer structures 308 (e.g., heat transfer properties, corrosion resistance, mechanical strength) increase the durability and the useful life of the fuel rods 100, 200, 300, 400, 700.

While embodiments of the disclosure may be susceptible to various modifications and alternative forms, specific embodiments have been shown by way of example in the drawings and have been described in detail herein. However, it should be understood that the disclosure is not limited to the particular forms disclosed. Rather, the disclosure encompasses all modifications, variations, combinations, and alternatives falling within the scope of the disclosure as defined by the following appended claims and their legal equivalents.

What is claimed is:

1. A nuclear fuel rod, comprising:
a nuclear fuel material;
a material surrounding the nuclear fuel material and comprising a non-radioactive material; and
cladding surrounding the material, the material defining a fuel-cladding gap between the nuclear fuel material and the cladding.

2. The nuclear fuel rod of claim 1, wherein the fuel-cladding gap is within a range of from about 10 μm to about 1,000 μm.

3. The nuclear fuel rod of claim 1, wherein the material exhibits a greater thermal conductivity than a thermal conductivity of the nuclear fuel material.

4. The nuclear fuel rod of claim 1, wherein the material comprises a metal material.

5. The nuclear fuel rod of claim 1, wherein the material exhibits a void fraction within a range of from about 0.10 to about 0.90.

6. The nuclear fuel rod of claim 1, wherein the material comprises a foam material.

7. The nuclear fuel rod of claim 1, wherein the material comprises an auxetic material.

8. The nuclear fuel rod of claim 1, wherein the material directly contacts the nuclear fuel material and the cladding.

9. The nuclear fuel rod of claim 1, wherein the material comprises rods extending from the nuclear fuel material to the cladding.

10. The nuclear fuel rod of claim 9, wherein a longitudinal axis of each rod is substantially parallel with longitudinal axes of other rods.

11. The nuclear fuel rod of claim 9, wherein an angle between a longitudinal axis of each rod and a longitudinal axis of the nuclear fuel rod is within a range of from about 10° to about 90°.

12. The nuclear fuel rod of claim 1, wherein the material comprises a randomly dispersed network of wire.

13. The nuclear fuel rod of claim 1, wherein a median pore size of the material is within a range of from about 1.0 μm to about 5.0 mm.

14. A nuclear fuel rod, comprising:
nuclear fuel pellets;
cladding around the nuclear fuel pellets; and
a gap-maintaining material between the nuclear fuel pellets and the cladding and comprising a different material composition than the nuclear fuel pellets and the cladding, the gap-maintaining material contacting the nuclear fuel pellets and the cladding.

15. The nuclear fuel rod of claim 14, wherein the gap-maintaining material comprises:
a matrix material; and
thermal transfer structures dispersed within the matrix material and extending from the nuclear fuel pellets to the cladding.

16. The nuclear fuel rod of claim 14, wherein the gap-maintaining material defines one or more channels extending along a longitudinal axis of the nuclear fuel rod.

17. The nuclear fuel rod of claim 14, wherein a density of the gap-maintaining material is within a range of from about 5.0 g/cm³ to about 10.0 g/cm³.

18. The nuclear fuel rod of claim 14, wherein the gap-maintaining material exhibits a porosity within a range of from about 80 to about 95.

19. A method of forming a structure, the method comprising:
forming, by additive manufacturing, a first layer of a structure, the first layer comprising a first material;
forming a second layer of the structure on the first layer, the second layer comprising a sacrificial material;
forming a third layer of the structure on the second layer, the third layer comprising a second material having a different material composition than the first material; and
selectively removing the sacrificial material with respect to the first material and the second material to form a structure comprising the first material spaced from the second material.

20. The method of claim 19, wherein forming a second layer of the structure on the first layer comprises forming the second layer comprising silicon nitride or silicon dioxide on the first layer.

21. The method of claim 19, wherein selectively removing the sacrificial material with respect to the first material and the second material comprises exposing the sacrificial material to an acid.

22. The method of claim 19, wherein selectively removing the sacrificial material with respect to the first material and the second material comprises exposing the sacrificial material to electromagnetic radiation.

23. The method of claim 19, wherein:
forming, by additive manufacturing, a first layer of a structure comprises forming the first layer of the structure to comprise a cladding material; and
forming a third layer of the structure on the second layer comprises forming a third layer comprising a nuclear fuel material.
